(19) United States
(12) Patent Application Publication
(10) Pub. No.: US 2024/0025506 A1
(43) Pub. Date: Jan. 25, 2024

(54) Electric Bicycle

(71) Applicant: Robert Bosch GmbH, Stuttgart (DE)

(72) Inventors: Thomas Stiffel, Kirchentellinsfurt (DE); Jian Liu, Lund (SE); Ramtin Razdar, Lund (SE)

(21) Appl. No.: 18/348,669

(22) Filed: Jul. 7, 2023

(30) Foreign Application Priority Data
Jul. 21, 2022 (DE) 10 2022 207 462.9

(51) Int. Cl. B62J 50/22; B62M 6/90

(52) U.S. Cl. CPC B62J 50/22; B62M 6/90; B62H 5/20

(57) ABSTRACT

An electric bicycle includes a drive unit, a control unit for controlling or regulating the electric bicycle, and a communications unit for transmitting and/or receiving data, wherein the communications unit has a first radio interface for connection to a radio mast. It is proposed that the communications unit have a second radio interface for connection to a radio mast.

This application claims priority under 35 U.S.C. § 119 to application no. DE 10 2022 207 462.9, filed on Jul. 21, 2022 in Germany, the disclosure of which is incorporated herein by reference in its entirety.

The disclosure relates to an electric bicycle having a drive unit, a control unit for controlling or regulating the electric bicycle, and a communications unit for transmitting and/or receiving data, wherein the communications unit has a first radio interface for connection to a radio mast. It is proposed that the communications unit have a second radio interface for connection to a radio mast. This can advantageously improve the exchange of data between the electric bicycle and the user.

### BACKGROUND

EP 3 159 254 A1 describes a bicycle with a data radio link device.

### SUMMARY

In the context of this application, the term, “electric bicycle,” is in particular intended to mean a bicycle having a drive unit for assisting the rider. The electric bicycle is preferably designed as an e-bike, a pedelec, a cargo bicycle, a folding bicycle, or the like. The drive unit has a motor, which can, for example, be designed as a mid-motor or as a hub motor. The motor is preferably designed as an electric motor. The drive unit is connected to a power supply—in particular, in the form of a battery pack—for supplying energy to the drive unit. The battery pack has a housing that is preferably detachably connected to a frame of the bicycle. The battery pack is preferably designed as an exchangeable battery pack that is preferably designed with the consumer to be detachable without tools. Alternatively, a permanently integrated battery pack is also conceivable. The battery pack is in particular designed to be connectable to a charging device for charging the battery pack. Alternatively or additionally, the battery pack may also be designed in such a way that it can be charged when it is connected to the consumer—for example via a charging socket on the battery pack or on the frame of the electric bicycle. The battery pack has a housing in which at least one battery cell is arranged.

The electric bicycle has electronics. The electronics in particular comprise one or more printed circuit boards on which electronic components are arranged and connected to one another. The electronics may have a computing unit, e.g., in the form of a processor, a memory unit for storing data, a sensor unit for acquiring information, etc. The control unit is assigned to the electronics. The sensor unit can, for example, have motion sensors, torque sensors, speed sensors, a GNSS receiver, magnetic sensors, or the like.

The communications unit is also assigned to the electronics. The first radio interface and the second radio interface may be designed as a chip or as a module, which are preferably arranged on the printed circuit board of the electronics. For example, it is conceivable that the first radio interface and the second radio interface be arranged in the same module. The radio interfaces are intended for long-range communication. The radio interfaces can connect directly to the radio masts. The radio interfaces are in particular designed such that the radio interfaces, e.g., two first radio interfaces of two electric bicycles, cannot be connected directly to one another, but, rather, the connection must be made via a radio mast. The radio interfaces are preferably designed as mobile communication interfaces. The first radio interface and the second radio interface are preferably assigned to different mobile communication technologies. For example, the first radio interface may be designed as a GSM radio interface, and the second radio interface may be designed as an LTE radio interface. Alternatively, it is also conceivable that the first radio interface and the second radio interface be assigned to the same mobile communication technology, wherein the first radio interface and the second radio interface differ in terms of specification or mobile communications standard. It is also conceivable that the first radio interface and the second radio interface be assigned to the same mobile communications standard, e.g., the 3GPP standard, but preferably differ in terms of specification. In addition, the communications unit comprises at least one device radio interface designed to directly connect the electric bicycle to a mobile terminal or an infrastructure element. For example, the device radio interface may be designed as an RFID interface, a Bluetooth interface, a WLAN interface, or the like. Alternatively or additionally, the device radio interface may be designed to connect different bicycle components, e.g., an on-board computer, to a battery pack, a lighting unit, a gear shift, etc.

Furthermore, it is proposed that the communications unit be designed such that either the first radio interface or the second radio interface is connected to the radio mast. Advantageously, an efficient communications unit can thereby be provided. Alternatively, it is also conceivable that the communications unit have a third radio interface, a fourth radio interface, and/or further radio interfaces. Preferably, only one of the radio interfaces at a time is connected to a radio mast. Alternatively, it is also conceivable that the two radio interfaces or even several radio interfaces be connected to one radio mast or several radio masts simultaneously.

It is also proposed that the first radio interface have a higher data transmission rate than the second radio interface. Advantageously, the radio interface can thus be selected depending on the data transmission requirement.

It is further proposed that the first radio interface be able to establish a connection faster than the second radio interface. A faster establishment of a connection should in particular be understood to mean that a time period or an average time period necessary for establishing a wireless communications link between the first radio interface and the radio mast is shorter than a time period or an average time period necessary for establishing a wireless communications link between the second radio interface and the radio mast. The first radio interface in particular establishes a connection at least 25%, preferably at least 50%, and preferably at least 100%, faster than the second radio interface.

In addition, it is proposed that the first radio interface have a faster switching time between two radio masts than the second radio interface. This can advantageously ensure optimal communication during mobile operation of the electric bicycle. A switching time between two radio masts is in particular to be understood as a period of time that spans a loss of connection or a connection termination from a first radio mast and an establishment of a connection to a second radio mast. The switching time of the first radio interface is in particular at least 25%, preferably at least 50%, and preferably at least 100%, faster than the switching time of the second radio interface.

Furthermore, it is proposed that the second radio interface have greater penetration than the first radio interface. A connection of the electric bicycle to a radio mast can thus advantageously be realized even in enclosed spaces. In the context of this application, penetration is in particular to be understood as building penetration. Greater penetration has the effect that a maximum range of the radio interface is less influenced by buildings, walls, or other infrastructure.

It is further proposed that, for establishing a connection, the control unit be designed to select the first radio interface or the second radio interface based upon an electric bicycle parameter, a control parameter, and/or a radio parameter. Advantageously, an optimal connection can thus always be ensured. An electric bicycle parameter may be understood, for example, to be a state of charge of the power supply unit of the electric bicycle, a state of motion of the electric bicycle—in particular, a standstill of the electric bicycle—a switching-on of the electric bicycle, etc. A control parameter is to be understood in particular to be an input of a user of the electric bicycle—for example via a mobile terminal, in particular via a smartphone, or via an on-board computer of the electric bicycle. A radio parameter may be understood to mean, for example, the presence of a loss of connection, or a signal strength of the radio signal of the connected radio mast.

It is also proposed that the first radio interface and/or the second radio interface be configured such that it can be switched to inactive. Advantageously, this allows the communications unit to be optimally adapted in applications in which essentially only one radio interface is permanently required or one of the radio interfaces cannot be used. A radio interface switched to inactive is not used by the control unit of the electric bicycle to select which radio interface is used to establish the connection. The switch to inactive can be performed by the user—for example by an input on the on-board computer or a mobile terminal, such as a smartphone. However, it is also conceivable that a control signal for switching a radio interface to inactive be transmitted by a radio mast directly to the electric bicycle or indirectly to the electric bicycle via a mobile terminal. Automatic activation and/or deactivation based upon geodata is also conceivable.

Furthermore, it is proposed that the communications unit be configured to transmit geodata and/or operating data of the electric bicycle. For example, the operating data may be a state of motion of the electric bicycle or a state of charge of the electric bicycle.

It is further proposed that the control unit be designed to switch the radio interface when the connection is lost. The loss of connection can be triggered, for example, by the loss of a radio signal from the radio mast or by a signal strength below a threshold value.

It is also proposed that the control unit be designed to switch the radio interface when a state of motion changes. The communications unit can thus advantageously be optimally adapted to different situations. The state of motion is preferably ascertained by the electric bicycle, in particular the control unit of the electric bicycle. This may be done, for example, by means of a motion sensor and/or a speed sensor. Alternatively, the state of motion can also be ascertained via a state of the motor of the drive unit. For example, the state of motion may be in the form of a standstill, a ride—in particular a slow ride or a fast ride—a fall, or the like. Alternatively, it is also conceivable that the state of motion comprise one or more motion parameters—for example in the form of a speed or an acceleration.

Furthermore, it is proposed that the control unit be configured to switch the radio interface, based upon an energy-saving mode. Advantageously, the range of the electric bicycle can thereby be increased. An energy-saving mode is in particular intended to mean a state of the first radio interface and/or the second radio interface, in which no or limited data are transmitted and/or received. The energy-saving mode may be configured as an energy-saving mode of the communications unit, in particular an energy-saving mode of the first radio interface and/or the second radio interface. The energy-saving mode may be configured as an inactive state, a light sleep, or a deep sleep. The control unit is preferably configured to switch to the second radio interface when switching to the energy-saving mode. Further, it is conceivable to switch to the first radio interface when switching out of the energy-saving mode. The energy-saving mode may also be configured as an energy-saving mode of the electric bicycle that can be set by the user and/or is automatically activated by the control unit of the electric bicycle—for example in the case of a reserve battery pack.

It is further proposed that the control unit be configured to switch the radio interface, based upon a state of charge of a power supply of the electric bicycle. The control unit is in particular configured to switch the radio interface when the state of charge of the battery pack of the electric bicycle is less than 50%, preferably less than 25%, and preferably less than 10%.

### BRIEF DESCRIPTION OF THE DRAWINGS

Further advantages are apparent from the following description of the drawings. The drawings, the description, and the disclosure contain numerous features in combination. The person skilled in the art will expediently also consider the features individually and combine them to form further meaningful combinations.

Shown are:

FIG. 1 a side view of an electric bicycle with a communications unit;

FIG. 2 a schematic view of a system including the electric bicycle of FIG. 1, with a mobile terminal, a radio mast, and a server; and

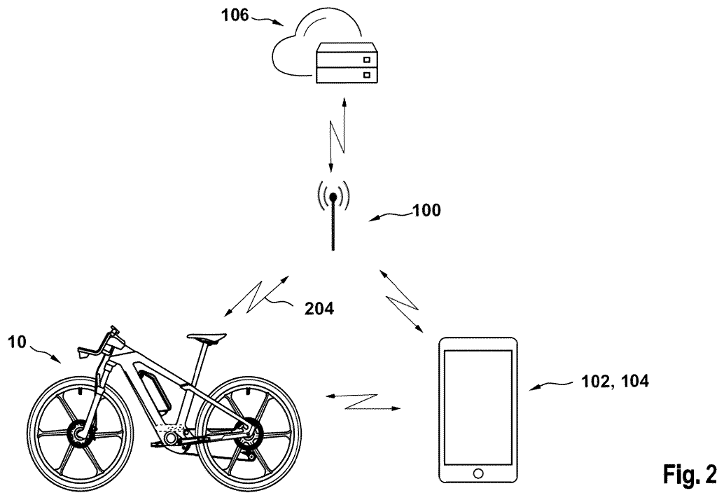

FIG. 3 a flowchart with a method for switching a radio interface.

### DETAILED DESCRIPTION

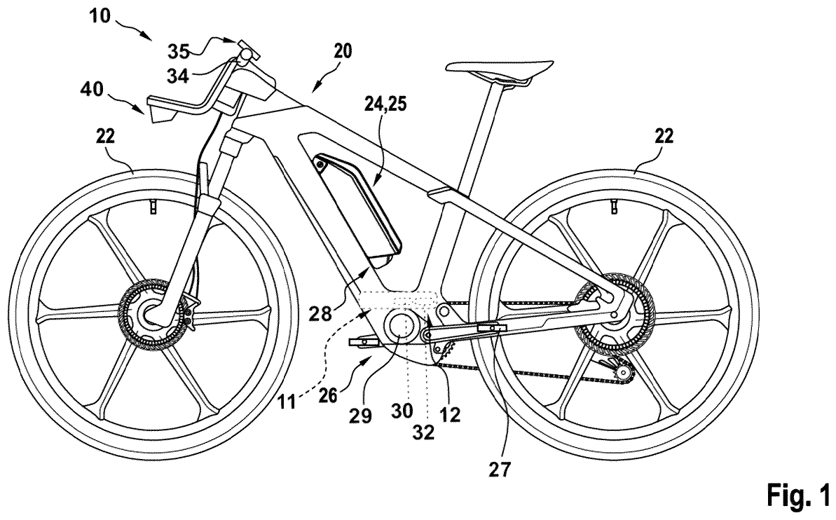

In FIG. 1, a side view of an electric bicycle 10 with a communications unit 12 is shown. For example, the electric bicycle 10 can be designed as a pedelec or as an e-bike.

The electric bicycle 10 has a housing in the form of a frame 20 or a bicycle frame. Connected to the frame 20 are two wheels 22. In addition, the electric bicycle 10 has an energy store 24 in the form of a battery pack 25. The electric bicycle 10 also has a drive unit 26, which comprises an electric motor or an auxiliary motor. The electric motor is preferably designed as a permanent magnet-excited, brushless DC motor. The electric motor is, for example, designed as a mid-motor, wherein a hub motor or the like also is conceivable. The electric bicycle 10, and in particular the drive unit 26 of the electric bicycle 10, is powered via the energy store 24. The battery pack 25 is connected to the electric bicycle 10, and in particular to the frame 20 of the electric bicycle 10, by means of a connection device 28. The connection is made by way of a pivoting movement of the battery pack 25 relative to the electric bicycle 10, as an example.

The drive unit 26 comprises a control unit 11 designed to control or regulate the electric bicycle 10, in particular the electric motor. The electric bicycle 10 has a pedal crank 27. The pedal crank 27 has a pedal crankshaft (not shown). The control unit 11 of the electric bicycle 10 is connected to a sensor unit (not shown). The sensor unit of the electric bicycle 10 comprises, for example, multiple sensor elements, such as a torque sensor, a motion sensor, e.g., in the form of an acceleration sensor, a GNSS receiver, and a magnetic sensor. Also, the communications unit 12 is assigned to the control unit 11.

The control unit 11 and the drive unit 26 having the electric motor and the pedal crankshaft are arranged within a drive housing 29 connected to the frame 20. The drive motion of the electric motor is preferably transferred to the pedal crankshaft via a gear (not shown), wherein the magnitude of assistance by the drive unit 26 is controlled or regulated by means of the control unit 11. The control unit 11 is designed to control the drive unit 26 such that the rider of the electric bicycle 10 is assisted in pedaling. Preferably, the control unit 11 is designed to be operable by the rider so that the rider can set the assistance level.

The control unit 11, the communications unit 12, and the sensor unit are assigned to electronics (not shown) of the electric bicycle 10. The electronics comprise, e.g., a printed circuit board on which are arranged a computing unit in the form of a CPU, a memory unit, and the sensor unit. The electronics are, for example, arranged entirely within the drive housing 29 of the drive unit 26. However, it is also conceivable that the electronics be only partially arranged in the drive housing 29 and that components of the electronics be arranged in other areas of the electric bicycle 10. In addition, an arrangement of the electronics outside the drive housing 29 is also conceivable.

The electric bicycle 10 also comprises, by way of example, an on-board computer 35 arranged on a handlebar 34 of the electric bicycle 10. The on-board computer 35 is, by way of example, designed to be in part detachable from the electric bicycle 10. The on-board computer 35 comprises a display unit (not shown) designed to display information. The on-board computer 35 also comprises an operating element (not shown) via which the user or the rider can control the on-board computer 35 and/or the electric bicycle 10. The operating element is, for example, designed as a touchscreen. The on-board computer 35 is connected to the control unit 11 of the electric bicycle 10 such that information can be exchanged. For example, the display unit can display a speed determined by the control unit 11, a set assistance level of the electric motor, route information of a navigation unit, and a state of charge of the battery pack 25.

The communications unit 12 comprises a first radio interface 30 and a second radio interface 32. The first radio interface 30 and the second radio interface 32 are designed to connect directly to a radio mast 100. The first radio interface 30 and the second radio interface 32 are assigned to different radio standards. By virtue of the different radio standards, the radio interfaces 30, 32 differ in their properties. By way of example, the first radio interface 30 is designed such that the first radio interface 30 has a higher data transmission rate, faster establishment of a connection to the radio mast 100, and a shorter switching time between two radio masts 100 than the second radio interface 32. The second radio interface 32 is preferably configured such that the second radio interface 32 has greater penetration than the first radio interface 30. For example, the first radio interface 30 may be configured as an LTE-M interface, in particular as an LTE-CAT-M1 interface. For example, the second radio interface 32 may be configured as a narrowband IoT interface.

In addition, the communications unit 12 comprises a device radio interface (not shown), which is designed as a BLE (Bluetooth Low Energy) interface by way of example. The device radio interface differs from the first radio interface 30 and the second radio interface 32 in particular in that a direct connection to the radio mast 100 is not possible. The device radio interface is in particular designed to connect the electric bicycle 10 to a mobile terminal 102, e.g., a smartphone 104, for data exchange. In addition, the device radio interface is, by way of example, designed to connect the electric bicycle 10 to additional components, such as a lighting unit 40 and an electronic gear shift (not shown). This advantageously enables a connection to be made between the control unit 11 of the electric bicycle 10 and the additional components such that they are controllable by the control unit 11 and/or the on-board computer 35 of the electric bicycle 10 and/or the mobile terminal 102, and/or information, e.g., status information, can be displayed.

The communications unit 12 is in particular configured for communication of the electric bicycle 10 with a server 106, a computing network, or a cloud. The connection may be made directly via the first radio interface 30 or the second radio interface 32, or indirectly via the device radio interface of the electric bicycle 10 and the mobile terminal 102. The mobile terminal 102 here comprises also at least one radio interface (not shown). The radio interface of the mobile terminal 102 may in this case have a first radio interface and/or a second radio interface and/or a further radio interface having a different radio standard.

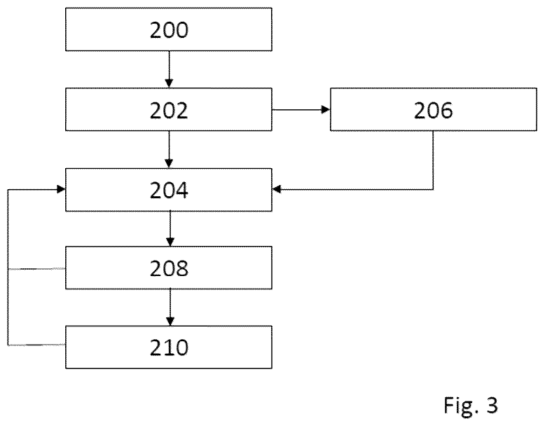

In FIG. 3, a flowchart shows an exemplary method for connecting the electric bicycle 10 to the radio mast 100. At any time, only the first radio interface 30 or the second radio interface 32 is connected to the radio mast 100, and never both radio interfaces 30, 32 simultaneously.

In a method step 200, the electric bicycle 10, in particular the communications unit 102, preferably the first radio interface 30 and/or the second radio interface 32, is switched on and/or connected to the battery pack 25 or another energy source.

The control unit 11 of the electric bicycle 10 is configured to provide, by way of example, the radio interface 30, 32, which has previously been connected to the radio mast 100 or another radio mast, for connection in a method step 202. Preferably, the control unit 11 is configured to store at least the last connection operation or a history of connection operations in a memory unit. Alternatively, it would also be conceivable for one of the radio interfaces 30, 32, e.g., the first radio interface 30 that establishes a connection faster, to always be selected first by the control unit 11 of the electric bicycle 10 upon activation.

If the connection between, by way of example, the first radio interface 30 and the radio mast 100 is successful, data and information can be sent to the radio mast 100 or received from the radio mast 100 in a method step 204. In particular, a connection to the server 106 is possible.

If the connection operation fails, the other radio interface, e.g., the second radio interface 32, is used to establish a connection to the radio mast 100 in a method step 206. If, in this case, a connection to the radio mast 100 is possible, data exchange may again take place.

In a method step 208, a connection between one of the radio interfaces 30, 32 and the radio mast 100 is lost. The loss of connection may occur, for example, due to a spatially limited range of the radio mast 100. Alternatively, it is also conceivable for the electric bicycle 10 to be parked in a storage location, e.g., a basement or a garage, which, if there is low penetration of the radio interface, prevents the establishment of a connection.

Preferably, the control unit 11 of the electric bicycle 10 controls the communications unit 12 in a method step 210 such that the radio interface 30, 32 that has been previously connected performs a new connection operation to the radio mast 100 or another radio mast.

If the connection operation fails, the radio interface 30, 32 is switched in a further method step 210 and a connection operation with the other radio interface 30, 32 is performed.

The communications unit 12 is in particular configured to provide, by means of the first radio interface 30 or the second radio interface 32, geodata acquired via the GNSS receiver of the electric bicycle and operating data of the electric bicycle 10, e.g., a state of charge of the battery pack 25 and a state of motion of the electric bicycle 10, to the server 106 via the radio mast 100.

The data and information provided may be processed by the server 106 and/or used on the mobile terminal 102 to provide and/or display information to the user. This advantageously enables the user to check the location of the electric bicycle 10 and the state of charge even from a distance. In addition, the information may also be used to track the electric bicycle 10—for example, in the event of a theft.

It is also conceivable for the control unit 11 of the electric bicycle 10 to control the switch between the radio interfaces 30, 32 based upon an electric bicycle parameter. For example, it is conceivable for the radio interface with the lower power consumption to be selected when the state of charge is less than 25%. It is also conceivable for a connection switch to occur based upon a connection status of the device radio interface of the electric bicycle 10. For example, if there is no connection between the electric bicycle 10 and the mobile terminal 102 and the state of motion of the electric bicycle 10 is a standstill, it can be assumed that the electric bicycle 10 is in the storage state. Advantageously, in this case, the radio interface with greater penetration and/or lower power consumption may be selected. The state of motion is preferably determined by the control unit 11 of the electric bicycle 10.

What is claimed is:

1. An electric bicycle comprising:
a drive unit:
a control unit configured to control or regulate the electric bicycle; and
a communications unit configured to transmit and/or receiving data,
wherein
the communications unit has a first radio interface configured to connect to a first radio mast, and
the communications unit has a second radio interface configured to connect to the first radio mast.

2. The electric bicycle according to claim 1, wherein the communications unit is designed such that either the first radio interface or the second radio interface is connected to the radio mast.

3. The electric bicycle according to claim 1, wherein the first radio interface has a higher data transmission rate than the second radio interface.

4. The electric bicycle according to claim 1, wherein the first radio interface is configured to establish a connection faster than the second radio interface.

5. The electric bicycle according to claim 1, wherein the first radio interface has a faster switching time between the first radio mast and a second radio mast than the second radio interface.

6. The electric bicycle according to claim 1, wherein the second radio interface has a greater penetration than the first radio interface.

7. The electric bicycle according to claim 1, wherein, for establishing a connection, the control unit is configured to select the first radio interface or the second radio interface based upon an electric bicycle parameter, a control parameter, and/or a radio parameter.

8. The electric bicycle according to claim 1, wherein the first radio interface and/or the second radio interface is configured to be switchable to inactive.

9. The electric bicycle according to claim 1, wherein the communications unit is further configured to transmit geodata and/or operating data of the electric bicycle.

10. The electric bicycle according to claim 1, wherein the control unit is further configured to switch between the first and second radio interface when a connection between either of the first and second radio interface and the first radio mast is lost.

11. The electric bicycle according to claim 1, wherein the control unit is further configured to switch between the first and second radio interface when a state of motion changes.

12. The electric bicycle according to claim 1, wherein the control unit is further configured to switch between the first and second radio interface based upon an energy-saving mode.

13. The electric bicycle according to claim 1, wherein the control unit is further configured to switch between the first and second radio interface based upon a state of charge of an energy store of the electric bicycle.
